(19) United States
(12) Patent Application Publication
(10) Pub. No.: US 2002/0165801 A1
(43) Pub. Date: Nov. 7, 2002

(54) System to interpret item identifiers

(76) Inventors: Edith H. Stern, Yorktown Heights, NY (US); Barry E. Willner, Briarcliff Manor, NY (US); David P. Greene, Ossining, NY (US)

Correspondence Address: BUCKLEY, MASCHOFF, TALWALKAR, & ALLISON, 5 ELM STREET, NEW CANAAN, CT, 06840, US

(21) Appl. No.: 09/847,779

(22) Filed: May 2, 2001

(51) Int. Cl. G06F 17/60

(52) U.S. Cl. 705/27

(57) ABSTRACT

A system to obtain item information includes capture of an image of an item identifier, transmission of the image, and, in response to the transmission, reception of item information associated with an item identified by the item identifier. Embodiments of this system allow usage of item identifiers and associated item information by any system in which an image can be transmitted and item information can be received.

### BACKGROUND OF THE INVENTION

1. Field of the Invention

The present invention relates to systems for obtaining item information. More specifically, the present invention concerns a system to provide item information based on an item identifier such as a barcode.

2. Description of the Related Art

Barcodes have long been used by retailers to identify, track and manage items. A barcode encodes information related to an item with which the barcode is associated. Typically, a barcode is associated with an item by affixing the barcode to the item or to the item's packaging.

In order to use a barcode associated with an item, a retailer first extracts encoded information from the barcode using a barcode scanner. The extracted information may consist of an identification code such as a Stock Keeping Unit (SKU). Of course, instead of scanning the barcode, the identification code may be manually read and entered into a device via a keyboard. In either case, the code may then be used to retrieve a retail price of the item from a database, to update a location of the item in a database, or to obtain warranty or other information regarding the item from a database. The extracted information itself may also consist of the retail price, warranty information, etc.

In view of the prevalence and usefulness of barcodes, many devices for extracting information therefrom have been developed for use by retailers and consumers. These devices include grocery checkout scanners, handheld scanners, and scanning pens. Peripheral modules capable of decoding barcodes are also being developed for devices such as Personal Digital Assistants (PDAs) and mobile telephones.

Some devices are capable of extracting information from barcodes of several different formats. One such system, the Cue Cat™ system by Digital:Convergence, operates by scanning a pen across a barcode obtained from a product or advertisement and by controlling a World Wide Web (“Web”) browser to access a Web page related to the product or advertisement. In view of the number and diversity of available barcode-decoding devices, the development and purchase of these devices represents a substantial capital investment by manufacturers and consumers alike.

The present situation presents two alternative problems. In one case, advances in optical, data compression and data representation technologies may lead to changes in standards for encoding and decoding barcodes that cannot be met by current-generation barcode scanners. As a result, substantial capital investment in these scanners will be lost. Moreover, subsequent technological advances may in turn cause the obsolescence of next-generation scanners and corresponding losses in capital investment.

In a second case, the momentum created by the current infrastructure of barcode devices will stifle development thereof. Specifically, perceived advantages of developing new barcode technology may not be seen as outweighing a loss in capital investment that would result from the replacement of devices displaced by the new technology. Consequently, the new technology will not be developed, and consumers and retailers may not receive net benefits that would have otherwise resulted therefrom.

In view of the foregoing, what is needed is a system to interpret item identifiers such as barcodes that encourages the development of better encoding and decoding standards, supports changes to these standards without requiring substantial capital investment, provides more diverse and flexible usage of item identifiers, and can be embodied in a general-purpose device.

### SUMMARY OF THE INVENTION

To address these needs, the present invention relates to a system for obtaining item information in which an image of an item identifier is captured, the image is transmitted, and, in response to the transmission, item information associated with an item identified by the item identifier is received. According to some embodiments, this aspect of the present invention reduces a need for an identifier-reading device to decode an item identifier locally. As a result, changes to decoding standards might not require any change to the identifier-reading device. It is believed that such an arrangement would therefore encourage development of such standards and increase usage of the system. Moreover, embodiments of this aspect allow easy usage of item identifiers and associated item information by any system capable of transmitting an image and receiving item information. These embodiments also may be used to provide a general-purpose device capable of interpreting item identifiers and obtaining item information.

In another aspect, the present invention concerns a system to provide item information in which an image of an item identifier is received, and, based on the received image, item information associated with an item identified by the item identifier is determined. Embodiments of this aspect advantageously allow a system to obtain item information based on an image of an item identifier. As described above, this capability may result in increased development of identifier encoding and decoding standards, easier adaptability to changed standards, and more diverse and flexible usage of item identifiers.

With these and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is a flow diagram of process steps to receive item information according to embodiments of the present invention.

FIG. 2 is a flow diagram of process steps to determine item information according to embodiments of the present invention.

FIG. 3 is a topographic view of a network architecture according to embodiments of the present invention.

FIG. 4 is a block diagram of an internal architecture of a central server according to embodiments to the present invention.

FIG. 5 is a block diagram of an internal architecture of a client device according to embodiments to the present invention.

FIG. 6 is a representative view of a tabular portion of an item information database according to embodiments of the present invention.

FIG. 7 is a representative view of a tabular portion of an information provider database according to embodiments of the present invention.

FIGS. 8A and 8B comprise a flow diagram of process steps to obtain item information using an image of an item identifier according to embodiments of the present invention.

### DETAILED DESCRIPTION

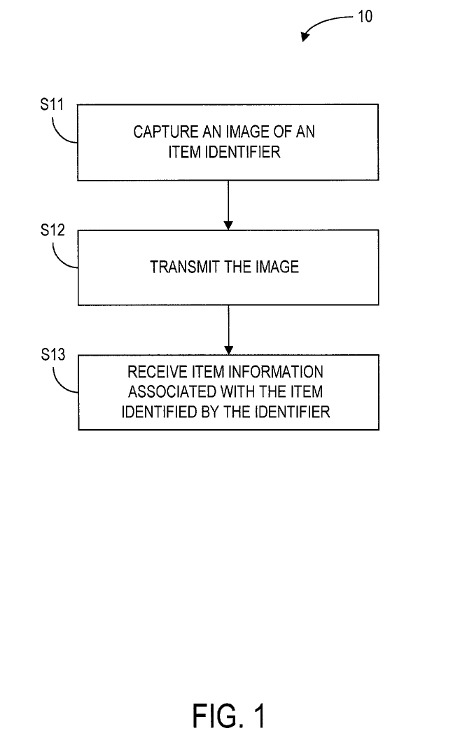

FIG. 1 is a flow diagram of process steps 10 to obtain item information according to embodiments of the present invention. In order to provide an immediate introduction to features of the present invention, process steps 10 will now be described without reference to a particular embodiment. Of course, a complete description of specific hardware and software embodiments of the claimed invention is set forth below.

Initially, an image of an item identifier is captured in step S11. In some embodiments of step S11, the item identifier is captured using a digital camera. Of course, the item identifier may be captured using any currently or hereafter known device for capturing images in any format.

An item identifier may comprise a barcode as described above, an image, text, or any other device usable to identify an item, including but not limited to a VCRplus code, a Web address, text in any font, a portion of the item, a color, and a texture. The item identifier may be located on the item, on or in the item's packaging, in a promotional offer, on circulated printed materials, on a product display, or on any other media from which an image of the identifier may be captured. In this regard, an item according to the present invention may include a product, a service, an event, a website, a location or any other entity for which information may be obtained.

The captured image is transmitted in step S12. For example, a digital camera used in step S11 may transmit the image to a remote device for processing of the image. In some embodiments, such processing includes decoding of the item identifier to determine item information associated with the product identifier. Accordingly, item information associated with the item is then received in step S13. It should be noted that the item information may be received by the device used in steps S11 and S12 or by another device.

The received item information may include any information associated with the item, such as a description, retail price, warranty information, expiration date, and availability information in any format, including machine-readable text. In a case that the item information comprises an expiration date, the date may be recorded in a countdown calendar managed by the client device. Advantageously, process steps 10 provide a system to obtain item information using an image capturing device without requiring the image capturing device to perform specialized decoding of an item identifier.

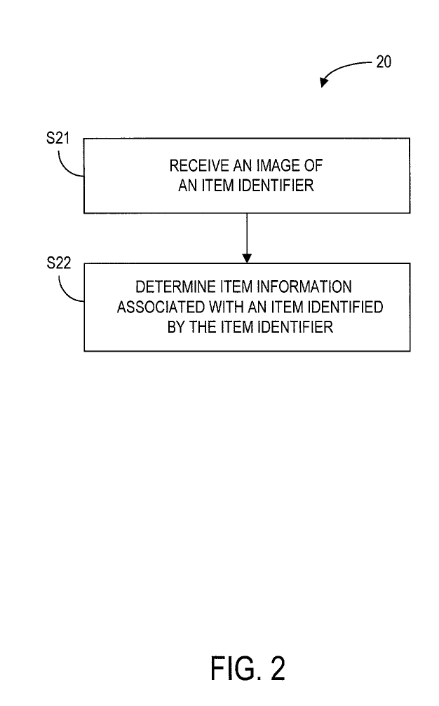

FIG. 2 is a flow diagram of process steps 20 to determine item information according to embodiments of the present invention. As in the description of FIG. 1, process steps 20 are described below without reference to a particular embodiment. Generally, process steps 20 represent process steps complementary to process steps 10.

In this regard, an image of an item identifier is received in step S21. The image may be received from a device transmitting the image according to step S12 of process steps 10. With respect to a specific example, a digital camera may capture the image and transmit the image in step S11 and step S12, respectively, and a central server may receive the image in step S21.

Item information is then determined in step S22. The determined item information is associated with an item identified by the received image. Item information may be determined in many ways depending upon the format of the image and the type of item identifier. For example, a received image may be identified as a barcode in a particular barcode format. The barcode is therefore decoded using an algorithm associated with the particular format to produce decoded item information. The decoded information may consist of a code that is then used to look up associated item information in a local or remote database. As a result, a system according to process steps 20 may determine item information from any type of item identifier as long as an algorithm for decoding the identifier is known. In some embodiments, the determined information is then transmitted to the device that transmitted the image of the item identifier.

### Network Architecture

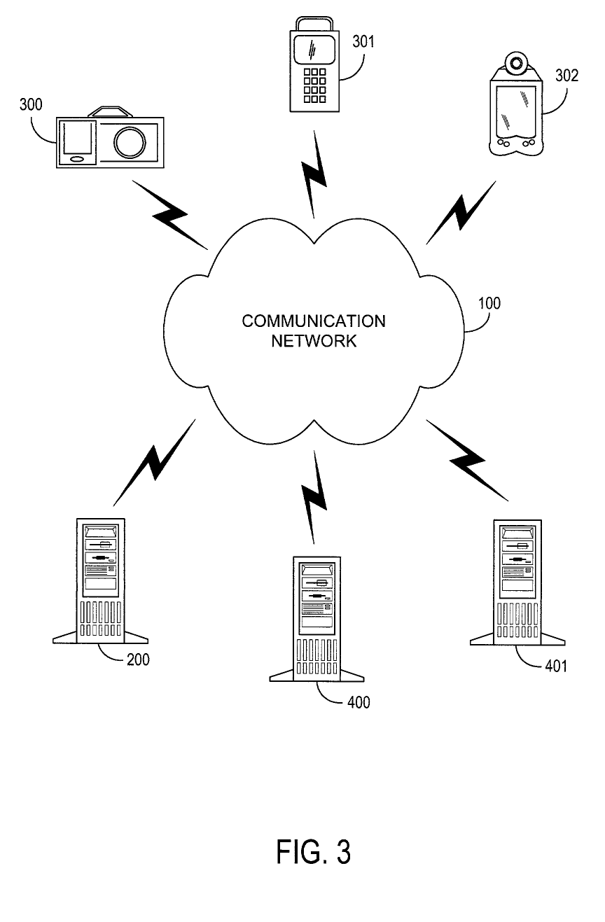

FIG. 3 is a topographic view of a network architecture according to embodiments of the present invention. Of course, network architectures other that that shown in FIG. 3 may be used to implement the invention.

FIG. 3 shows communication network 100 in communication with central server 200, client devices 300 to 302, and information providers 400 and 401. Communication network 100 may comprise any number of systems for transferring data, including a local area network, a wide area network, a telephone network, a cellular network, a fiber-optic network, a satellite network, an infra-red network, a radio frequency network, and any other type of network which may be used to transmit information between devices. Additionally, communication network 100 may be used to transmit data using any known transmission protocol, such as Asynchronous Transfer Mode (ATM), Internet Protocol (IP), Hypertext Transfer Protocol (HTTP) and Wireless Application Protocol (WAP). In one embodiment, communication network 100 is the World Wide Web.

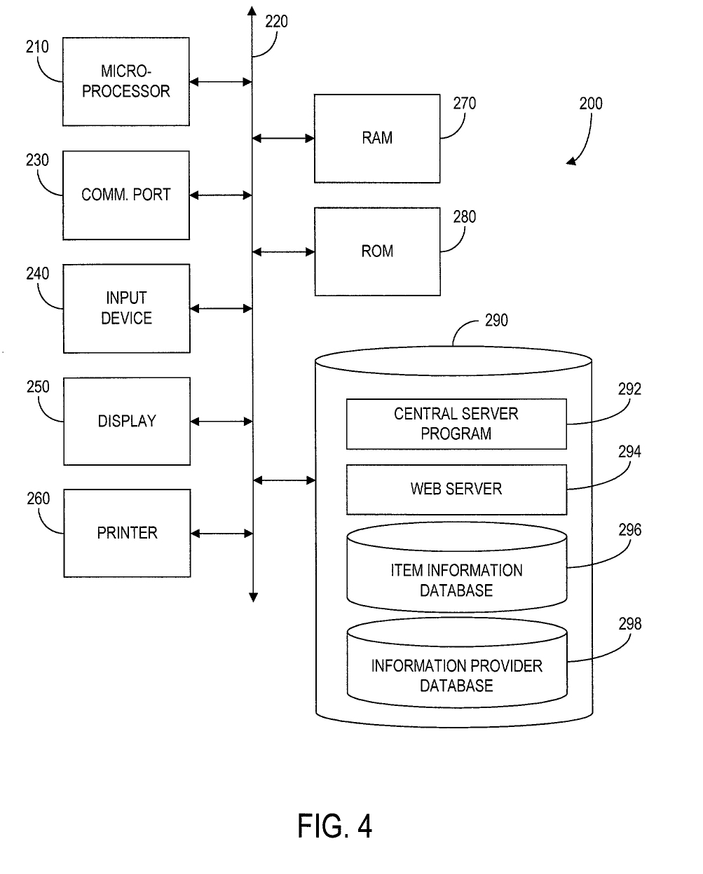

Central server 200 may comprise a network server or other device capable of performing the functions described herein. In addition to these functions, central server 200 may control various operations of an entity providing item information, including updating of decoding algorithms, billing, Web access, and the like. According to one embodiment, central server 200 operates to receive an image of an item identifier, and, based on the received image, to determine item information associated with an item identified by the item identifier. Details of one embodiment of central server 200 are set forth below with respect to FIG. 4.

Client devices 300 to 302 comprise a digital camera, a mobile telephone and a PDA, respectively. Each of consumer devices 300 to 302 includes peripherals for capturing an image, and may operate to capture an image of an item identifier, to transmit the image, and, in response to the transmission, to receive item information associated with an item identified by the item identifier. Although client devices 300 to 302 use similar systems for capturing images, image capture according to the invention may proceed using any system for capturing images in any format.

Information providers 400 and 401 comprise network servers and may be used to store item information and/or algorithms needed to decode images of item identifiers. Information providers 400 and 401 may also operate to decode item identifiers according to the stored algorithms. Moreover, each of information providers 400 and 401 may be operated by a different business entity and therefore may store only item information/decoding algorithms corresponding to items associated with the business entity.

In operation, one of client devices 300 to 302 captures an image of an item identifier and transmits the image to central server 200. Other central servers may exist, with the captured image being transmitted to a central server having a service contract with a user of the client device or with a retail store in which the image was captured. Central server 200 receives the image, determines the type of item identifier represented in the image, if necessary, and decodes the item identifier according to the determined type. Decoding the identifier results in a code that is transmitted to one of information providers 400 and 401 depending upon the format and/or content of the code. Generally, the code is transmitted to an information provider that stores item information associated with the code. The receiving information provider returns the associated item information to central server 200, which in turn transmits the item information back to the client device from which the image was received.

Many alternatives to the foregoing operation are contemplated. For example, the item identifier may be decoded by central server 200 to produce the item information that is transmitted to the client device, or the associated item information may be stored in central server 200 in association with the code. Also, the item information may be transmitted to the client device from the information provider rather than from central server 200. In addition, the item information may be transmitted to a client device different from the client device from which the image was received. In a specific example of the latter embodiment, a user may operate client device 302 to transmit images of item identifiers to central server 200. In response, central server 200 determines and transmits item information associated with each item identifier to the user's home PC to create a “wish list”, inventory or other compilation of the items. Such an embodiment is particularly advantageous in a case that the item information consists of data that it difficult to view on client device 302.

According to other embodiments, the elements of FIG. 3 are connected differently than as shown. For example, some or all of the elements may be connected directly to one another. Of course, embodiments of the invention may include elements that are different from those shown.

It should be noted that the devices shown in communication with each other might not be constantly exchanging data. Rather, communication may be established when necessary and severed at other times or always available but rarely used to transmit data. Moreover, although the illustrated communication links between the components of FIG. 3 appear dedicated, it should be noted that each of the links may be shared by other components.

### Central Server

FIG. 4 is a block diagram of the internal architecture of central server 200 according to one embodiment of the invention. As illustrated, central server 200 includes microprocessor 210 in communication with communication bus 220. Microprocessor 210 may be a Pentium™, RISC™-based, or other type of processor and is used to execute processor-executable process steps so as to control the components of central server 200 to provide functionality according to embodiments of the present invention.

Also in communication with communication bus 220 is communication port 230. Communication port 230 is used to transmit data to and to receive data from devices external to central server 200. Communication port 230 is therefore preferably configured with hardware suitable to physically interface with desired external devices and/or network connections. In one embodiment, images of item identifiers are received and item information is transmitted over communication port 230.

Input device 240, display 250 and printer 260 are also in communication with communication bus 220. Any known input device may be used as input device 240, including a keyboard, mouse, touch pad, voice-recognition system, or any combination of these devices. Input device 240 may be used by a business entity operating central server 200 to input item information and associated item identifiers, client device network addresses, information provider network addresses, and other information to central server 200. Of course, such information may also be input to central server 200 via communication port 230.

Display 250 may output text and graphics to an operator in response to commands issued by microprocessor 210, and may be an integral or separate CRT display, flat-panel display or the like. Printer 260 may also output text and graphics, but in hardcopy form using ink-jet, thermal, dot-matrix, laser, or other printing technologies.

RAM 270 is connected to communication bus 220 to provide microprocessor 210 with fast data storage and retrieval. In this regard, processor-executable process steps being executed by microprocessor 210 are typically stored temporarily in RAM 270 and executed therefrom by microprocessor 210. ROM 280, in contrast, provides storage from which data can be retrieved but to which data cannot be stored. Accordingly, ROM 280 is used to store invariant process steps and other data, such as basic input/output instructions and data used during system boot-up or to control communication port 230. It should be noted that one or both of RAM 270 and ROM 280 may communicate directly with microprocessor 210 instead of over communication bus 220.

Data storage device 290 stores central server program 292, Web server 294, item information database 296, and information provider database 298. Central server program 292 consists of processor-executable process steps executed by microprocessor 210 in order to control central server 200 to determine item information in accordance with the present invention. More specifically, the process steps of central server program 292 may be executed by microprocessor 210 to receive an image of an item identifier, to determine item information associated with an item identified by the item identifier based on the received image, and to transmit the determined item information. As a result, changes in item identifier decoding standards might not require any change to client devices.

The process steps of central server program 292 may be read from a computer-readable medium, such as a floppy disk, a CD-ROM, a DVD-ROM, a Zip™ disk, a magnetic tape, or a signal encoding the process steps, and then stored in data storage device 290 in a compressed, uncompiled and/or encrypted format. In alternative embodiments, hard-wired circuitry may be used in place of, or in combination with, processor-executable process steps for implementation of the processes of the present invention. Thus, embodiments of the present invention are not limited to any specific combination of hardware and software.

Web server 294 also comprises processor-executable process steps. The process steps may be executed by microprocessor 210 to transmit data to and to receive data from Web clients, such as Web browsers, over the Web.

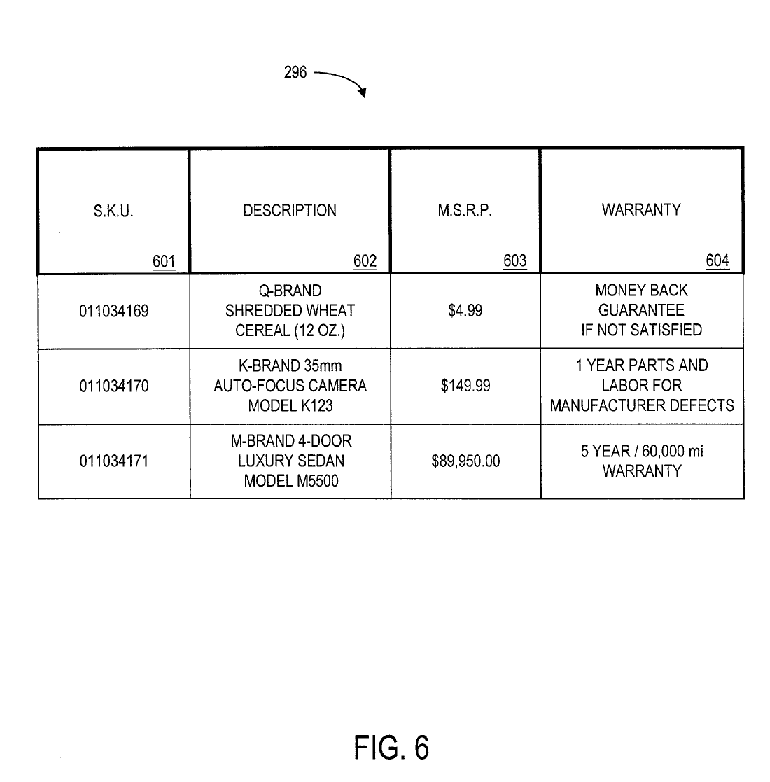

Item information database 296 includes item information associated with item identifiers. Accordingly, item information database 296 may be used to determine item information based on a received image of an item identifier. A specific example of a portion of item information database 296 will be described with respect to FIG. 6.

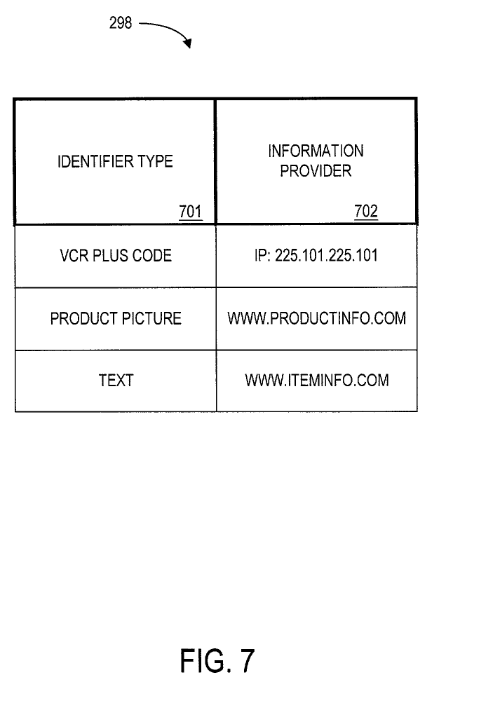

Stored in information provider database 298 is data used to communicate with information providers 400 and 401. More particularly, the data specifies information providers that are capable of determining item information associated with particular types of item identifiers. The data is therefore used to determine to which information provider an item identifier should be sent. Further details of information provider database 298 are set forth with respect to FIG. 7.

Data storage device 290 may also store other unshown elements that may be necessary for operation of central server 200, such as other applications, other data files, an operating system, a database management system and “device drivers” for allowing microprocessor 210 to interface with devices in communication with communication port 230. These elements are known to those skilled in the art, and are therefore not described in detail herein.

### Client Device

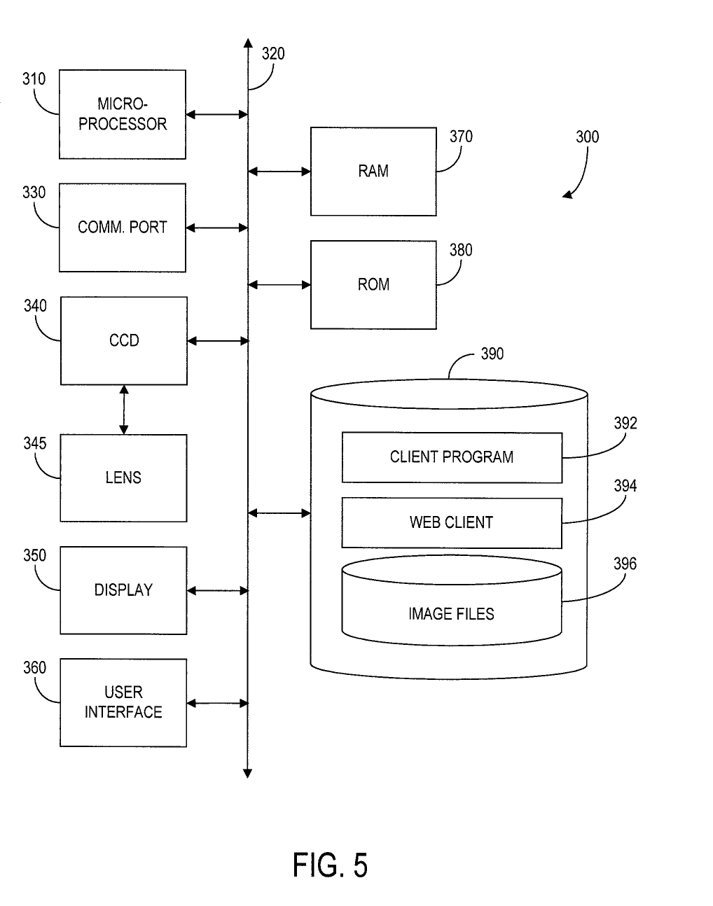

FIG. 5 illustrates several components of client device 300 according to one embodiment of the invention. The components may comprise any of the specific examples set forth above with respect to identically-named components of central server 200. Of course, specific functions performed by the components may differ from the functions performed by the identically-named components. For example, microprocessor 310 may be used to execute processor-executable process steps to obtain images of item identifiers and communication port 330 may be used to transmit the images and to receive item information based thereon.

Charge-coupled device (CCD) 340 is used to receive light impulses from lens 345 and to translate the impulses to an image signal. Accordingly, CCD 340 and lens 345 may be used to capture an image of an item identifier according to the present invention. Display 350 is used to present preview images to a user and to display information used to operate client device 300 such as remaining storage capacity, battery level, etc. User interface 360 allows a user to input data and commands to client device 300, including commands to capture an image of an item identifier and to transmit the image to central server 200.

Data storage device 390 stores client program 392 of processor-executable process steps. The process steps of client program 392 may be executed by microprocessor 310 so as to control client device 300 to capture an image of an item identifier, to transmit the image, and, in response to the transmission, to receive item information associated with an item identified by the item identifier. Of course, client program 392 may include process steps executable to provide other functions necessary for operation of client device 300.

Also stored in data storage device 390 are processor-executable steps of Web client 394. The process steps of Web client 394 may be executed by microprocessor 310 to allow client device 300 to send and receive over the Web. More specifically, Web client 394 allows client device 300 to transmit information to and to receive information from a device executing process steps of a Web server, such as central server 200.

Image files 396 are also stored in data storage device 390 and include those images captured by CCD 340 and lens 345. Image files 396 may include other image files as well.

### Item Information Database

A tabular representation of a portion of item information database 296 is shown in FIG. 6. The information stored in item information database 296 may be entered by an employee through input device 240 of central server 200, or may be received from a remote device over communication port 230. As described above, the information stored in item information database 296 may be used to determine item information based on a received image of an item identifier.

As shown, item information database 296 includes several records and associated fields. The fields include SKU field 601, description field 602, M.S.R.P. field 603, and warranty field 604. For a particular record, SKU field 601 specifies a SKU of a particular item. Similarly, description field 602, M.S.R.P. field 603 and warranty field 604 respectively include a description, a manufacturer's suggested retail price, and a warranty associated with the particular item. As such, the information stored in fields 601 to 604 is considered item information according to the present invention. Of course, item information database 296 may include many more records and each record may include fields other than those shown in FIG. 6.

One particular usage of item information database 296 proceeds as follows. An image of an item identifier is received by central server 200 and the item identifier is decoded to produce data shown in one of the fields of item information database 296. The item identifier may be decoded by central server 200 or by another device to which central server 200 transmits the item identifier, such as information provider 400. The decoded data is used to identify associated item information in item information database 296 and the item information is transmitted according to the invention.

### Information Provider Database

FIG. 7 shows a tabular representation of a portion of information provider database 298 according to embodiments of the invention. The data stored in information provider database 298 may be used to determine an information provider to whom an item identifier should be sent for decoding and/or determination of associated item information.

Each record in the illustrated portion of information provider database 298 includes identifier type field 701 and information provider field 702. As shown, identifier type field 701 specifies a particular type of item identifier and information provider field 702 provides a pointer to an information provider associated with the type of item identifier. Accordingly, the associated information provider may be capable of determining item information based on an item identifier of the particular type.

In a case that central server 200 cannot determine item information based on a received image of an item identifier of a particular type, central server 200 uses information provider database 298 to locate a pointer to an information provider associated with the particular type of item identifier. Using the pointer, central server 200 transmits the image of the item identifier to the information provider. In response, central server 200 receives associated item information from the information provider. Alternatively, the information provider transmits the item information to another entity such as a client device from which the image of the item identifier was received.

As will be understood by those skilled in the art, the illustrations and accompanying descriptions of item information database 296 and information provider database 298 merely represent relationships between stored information. A number of other arrangements may be employed besides those suggested by the illustrations. Similarly, the illustrated fields and field values represent sample information only; those skilled in the art will understand that the amount and content of this information may be different from that illustrated.

### Specific Example

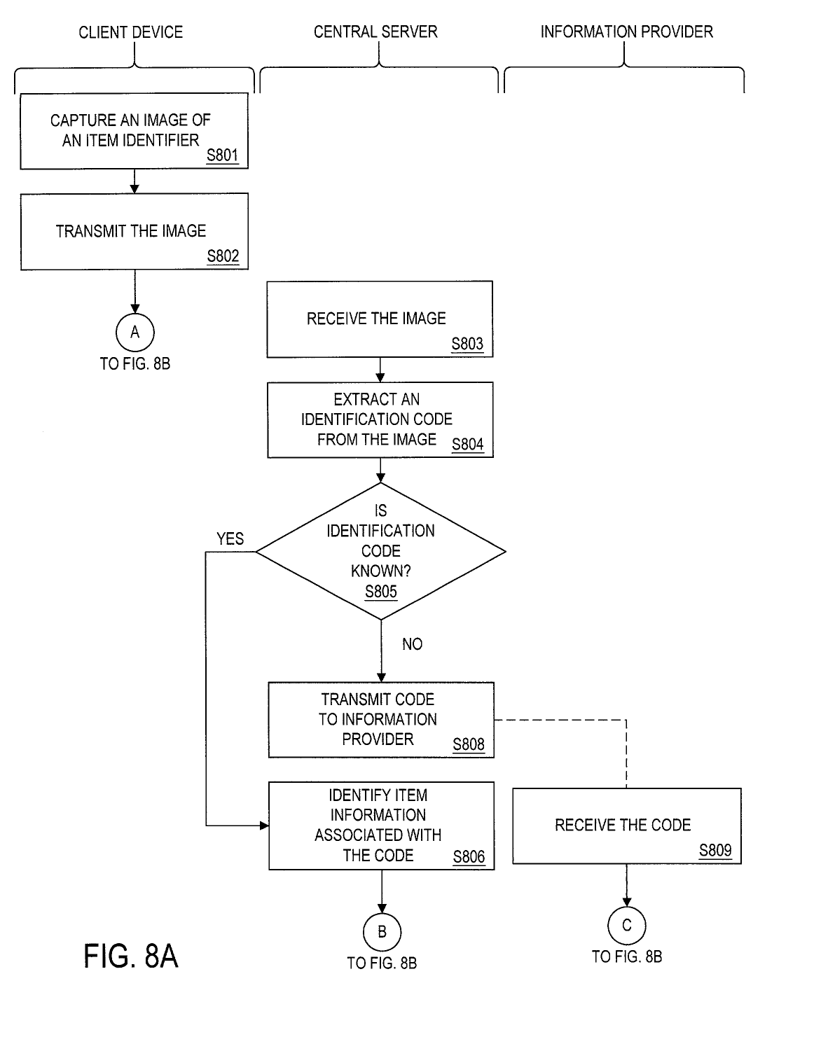

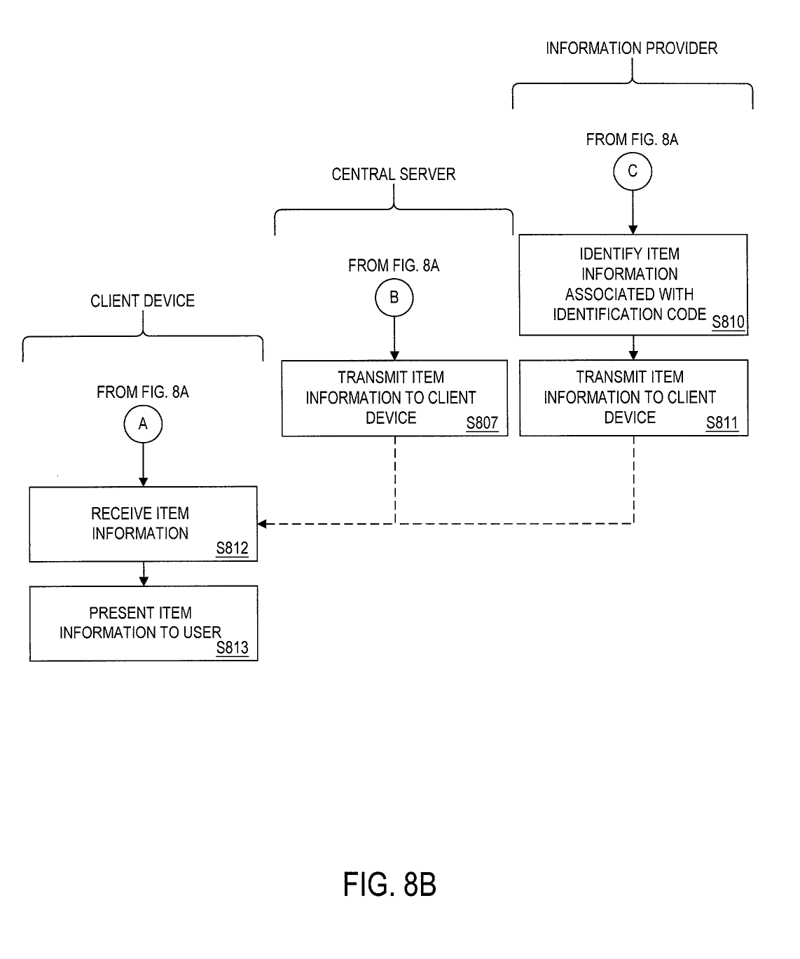

FIGS. 8A and 8B set forth process steps to obtain item information using an image of an item identifier according to some embodiments of the present invention. The process steps are described herein as being executed by client device 300, central server 200 and information provider 400. Of course, it should be noted that various ones of the process steps may be performed by any device or number of devices, and that some of process steps may be performed manually.

Briefly, according to FIGS. 8A and 8B, an image of an item identifier is captured, the image is transmitted, and, in response to the transmission, item information associated with an item identified by the item identifier is received. Moreover, an image of an item identifier is received, and, based on the received image, item information associated with an item identified by the item identifier is determined. By virtue of these features, the process steps of FIGS. 8A and 8B may provide improved standards for encoding and decoding item identifiers, easier adaptability to changed standards, and more diverse and flexible usage of item identifiers.

Initially, client device 300 captures an image of an item identifier in step S801. The image is transmitted to central server 200 in step S802. In this regard, client program 392 may provide a function for transmitting an image of an item identifier to central server 200. Accordingly, the function may be selected by a user prior to step S802 using user interface 360.

The image is received by central server 200 in step S803. Next, in step S804, central server 200 extracts an identification code from the image. The identification code may be extracted using known or future algorithms for interpreting item identifiers. For example, in a case that the image is determined to be an image of a barcode, a barcode-decoding algorithm is used to extract an identification code from the received image. Accordingly, it may be necessary to analyze the received image prior to step S804 in order to identify a type of item identifier represented by the image.

It is then determined in step S805 if the identification code is known. In the present example, the identification code is a SKU and item information database 296 is searched to identify a record including the SKU in SKU field 601. If such a record is identified, flow proceeds to step S806 to identify item information associated with the identification code in item information database 296. Continuing the example, the item information identified in step S806 consists of the information specified in the remaining fields of the located record. Next, in step S807, the identified item information is transmitted to client device 300.

Returning to step S805, flow proceeds therefrom to step S808 in a case that it is determined that the identification code is not known. In step S808, the identification code is transmitted to information provider 400. In this regard, an agreement may exist between entities operating central server 200 and information provider 400 allowing central server 200 to use information provider 400 to obtain item information. If central server 200 has similar agreements with other information providers, the code may be transmitted to information provider 400 rather than to another of the information providers based on factors such as the type or location of the client device, the format of the received image, and characteristics of the code.

Regardless of how information provider 400 is chosen to receive the code, information provider 400 receives the code in step S809. Next, in steps S810 and S811, information provider identifies item information associated with the identification code and transmits the information to client device 300 as described above with respect to steps S806 and S807. Accordingly, for the purposes of this example, information provider 400 is assumed to store a data structure associating identification codes with item information.

Client device 300 receives item information in step S812, either from central server 200 or from information provider 400. Next, the item information is presented to the user through display 350. In other embodiments, the item information is stored in data storage device 390 for later review, or, in the case that the item information comprises executable code, installed in client device 300 for later execution.

The process steps of FIGS. 8A and 8B may be altered to create embodiments of the invention according to any of the alternative arrangements mentioned herein. For example, the process steps may be altered such that central system 200 determines whether it is capable of extracting information from a received image of an item identifier. If not, the image is transmitted to an information provider determined based on the image type and on associated data stored in information provider database 298. In another alternative, a user of client device 300 may specify prior to step S802 a particular client device to receive item information. Accordingly, item information determined by central system 200 or information provider 400 is transmitted to the specified client device instead of to client device 300.

In other embodiments, an item identifier may comprise text and associated item information may comprise a machine-language equivalent of the text item identifier. Accordingly, such embodiments provide optical character recognition processing of text. In related embodiments, item information received in response to a transmitted text item identifier comprises executable code for performing optical character recognition processing on the item identifier. Both of these embodiments may be used to provide a general-purpose device with the ability to process text in an unlimited number of fonts.

According to some other embodiments, client device 300 may be used to capture an image of text, to transmit the image, and to receive a language translation of the text in machine-readable format. Specifically, client device 300 may capture an image of a French phrase and receive an English-language translation of the phrase in ASCII format. As a result, a client device embodying the present invention may provide item information, OCR processing, and language-translation.

In still other embodiments, an operator of central server 200 receives payment from a seller of an item in exchange for providing information associated with the item. The payment may be based on a number of times an image of an associated item identifier is received and/or a number of times item information associated with the item is transmitted. The payment may also be based on marketplace factors, including an increase in the seller's revenue attributable to central server 200 or an increase in inquiries relating to the item.

Moreover, although the present invention has been described with respect to particular embodiments and alternative arrangements thereof, those skilled in the art will note that various substitutions may be made to those embodiments and arrangements without departing from the spirit and scope of the present invention.

What is claimed is:

1. A method for obtaining item information, comprising:
capturing an image of an item identifier;
transmitting the image; and
in response to the transmission, receiving item information associated with an item identified by the item identifier.

2. A method according to claim 1, wherein the image is transmitted to a device.

3. A method according to claim 1, wherein the image is transmitted via a wireless connection.

4. A method according to claim 1, wherein the item identifier comprises at least one of a barcode, a VCRplus code, text, a portion of the item, a color, and a texture.

5. A method according to claim 4, wherein the item identifier is a Uniform Resource Locator.

6. A method according to claim 1, wherein the item identifier is an element of a promotional offer.

7. A method according to claim 1, wherein the item information comprises at least one of item specifications, warranty information, executable software, item availability information, Web page data, and a machine-readable version of a text identifier.

8. A method according to claim 7, wherein the item information comprises software for conducting optical character recognition.

9. A method according to claim 1, wherein the item identifier is located proximate to a location, and wherein the item information relates to the location.

10. A method according to claim 1, wherein the item information comprises an expiration date.

11. A method according to claim 10, further comprising recording the expiration date in a calendar.

12. A method according to claim 11, wherein the item identifier is an element of a promotional offer.

13. A method according to claim 12, wherein the item identifier is printed in circulated materials.

14. A method according to claim 11, wherein the calendar is a countdown calendar.

15. A method for providing item information, comprising:
receiving an image of an item identifier; and
determining, based on the received image, item information associated with an item identified by the item identifier.

16. A method according to claim 15, wherein the image is received from a device.

17. A method according to claim 16, further comprising:
transmitting the item information to the device.

18. A method according to claim 16, further comprising:
transmitting the item information to a second device.

19. A method according to claim 16, further comprising:
receiving a second image of a second item identifier from a second device; and
determining, based on the received second image, item information associated with a second item identified by the second item identifier.

20. A method according to claim 15, wherein the determining step comprises:
translating the received image into an identification code.

21. A method according to claim 20, wherein the determining step further comprises:
identifying the item information as being associated with the identification code.

22. A method according to claim 21, wherein the identifying step comprises:
transmitting the identification code to a device.

23. A method according to claim 22, wherein the identifying step further comprises:
receiving the item information from the device.

24. A method according to claim 23, wherein the device transmits the item information to a device from which the image was received.

25. A method according to claim 15, wherein the item identifier comprises at least one of a barcode, a VCRplus code, text, a portion of the item, a color, and a texture.

26. A method according to claim 25, wherein the item identifier is a Uniform Resource Locator.

27. A method according to claim 15, wherein the item identifier is an element of a promotional offer.

28. A method according to claim 15, wherein the item information comprises at least one of item specifications, warranty information, executable software, item availability information, Web page data, an expiration date, and a machine-readable version of a text identifier.

29. A method according to claim 28, wherein the item information comprises software for conducting optical character recognition.

30. A method according to claim 15, wherein the determining step further comprises:
determining a type of the received image; and
determining a method to obtain item information based on the type.

31. A method according to claim 15, wherein the item identifier is located proximate to a location, and wherein the item information relates to the location.

32. A method according to claim 15, further comprising:
receiving payment from a seller of the item.

33. A method according to claim 32, wherein the payment is based on a number of times the image is received.

34. A method according to claim 32, wherein the payment is based on an increase in the seller's revenue.

35. A system to interpret item identifiers, comprising:
a client device for capturing an image of an item identifier, for transmitting the image, and for receiving item information associated with an item identified by the item identifier in response to the transmission; and
a server for receiving the image and determining the item information based on the received image.

36. A system according to claim 35, further comprising:
an information provider for receiving the image from the server, for determining the item information, and for transmitting the item information to the server.

37. A system according to claim 35, further comprising:
an information provider for receiving the image from the server, for determining the item information, and for transmitting the item information to the client device.

38. A system according to claim 35, wherein the server receives a payment from a seller of the item.

39. A system according to claim 38, wherein the payment is based on a number of times the image is received.

40. A system according to claim 38, wherein the payment is based on an increase in the seller's revenue.

41. A medium storing processor-executable process steps to obtain item information, the process steps comprising:
a step to capture an image of an item identifier;
a step to transmit the image; and
a step to receive, in response to the transmission, item information associated with an item identified by the item identifier.

42. A medium according to claim 41, wherein the image is transmitted to a device.

43. A medium according to claim 41, wherein the image is transmitted via a wireless connection.

44. A medium according to claim 41, wherein the item identifier comprises at least one of a barcode, a VCRplus code, text, a portion of the item, a color, and a texture.

45. A medium according to claim 44, wherein the item identifier is a Uniform Resource Locator.

46. A medium according to claim 41, wherein the item identifier is an element of a promotional offer.

47. A medium according to claim 41, wherein the item information comprises at least one of item specifications, warranty information, executable software, item availability information, Web page data, and a machine-readable version of a text identifier.

48. A medium according to claim 47, wherein the item information comprises software for conducting optical character recognition.

49. A medium according to claim 41, wherein the item identifier is located proximate to a location, and wherein the item information relates to the location.

50. A medium according to claim 41, wherein the item information comprises an expiration date.

51. A medium according to claim 50, the process steps further comprising a step to record the expiration date in a calendar.

52. A medium according to claim 51, wherein the item identifier is an element of a promotional offer.

53. A medium according to claim 52, wherein the item identifier is printed in circulated materials.

54. A medium according to claim 51, wherein the calendar is a countdown calendar.

55. A medium storing processor-executable process steps to provide item information, the process steps comprising:
a step to receive an image of an item identifier; and
a step to determine, based on the received image, item information associated with an item identified by the item identifier.

56. A medium according to claim 55, wherein the image is received from a device.

57. A medium according to claim 56, the process steps further comprising:
a step to transmit the item information to the device.

58. A medium according to claim 56, the process steps further comprising:
a step to transmit the item information to a second device.

59. A medium according to claim 56, the process steps further comprising:
a step to receive a second image of a second item identifier from a second device; and
a step to determine, based on the received second image, item information associated with a second item identified by the second item identifier.

60. A medium according to claim 55, wherein the process step to determine item information:
a step to translate the received image into an identification code.

61. A medium according to claim 60, wherein the process step to determine item information further comprises:
a step to identify the item information as being associated with the identification code.

62. A medium according to claim 61, wherein the process step to identify the item information comprises:
a step to transmit the identification code to a device.

63. A medium according to claim 62, wherein the process step to identify the item information further comprises:
a step to receive the item information from the device.

64. A medium according to claim 62, wherein the device transmits the item information to a device from which the image was received.

65. A medium according to claim 55, wherein the item identifier comprises at least one of a barcode, a VCRplus code, text, a portion of the item, a color, and a texture.

66. A medium according to claim 65, wherein the item identifier is a Uniform Resource Locator.

67. A medium according to claim 55, wherein the item identifier is an element of a promotional offer.

68. A medium according to claim 55, wherein the item information comprises at least one of item specifications, warranty information, executable software, item availability information, Web page data, an expiration date, and a machine-readable version of a text identifier.

69. A medium according to claim 68, wherein the item information comprises software for conducting optical character recognition.

70. A medium according to claim 55, wherein the process step to determine item information further comprises:
a step to determine a type of the received image; and
a step to determine a medium to obtain item information based on the type.

71. A medium according to claim 55, wherein the item identifier is located proximate to a location, and wherein the item information relates to the location.

72. A medium according to claim 55, the process steps further comprising:
receiving payment from a seller of the item.

73. A medium according to claim 72, wherein the payment is based on a number of times the image is received.

74. A medium according to claim 72, wherein the payment is based on an increase in the seller's revenue.

75. An apparatus to obtain item information, comprising:
a processor; and
a storage device in communication with said processor and storing instructions adapted to be executed by said processor to:
capture an image of an item identifier;
transmit the image; and
receive, in response to the transmission, item information associated with an item identified by the item identifier.

76. An apparatus according to claim 75, wherein the image is transmitted to a device.

77. An apparatus according to claim 75, wherein the image is transmitted via a wireless connection.

78. An apparatus according to claim 75, wherein the item identifier comprises at least one of a barcode, a VCRplus code, text, a portion of the item, a color, and a texture.

79. An apparatus according to claim 78, wherein the item identifier is a Uniform Resource Locator.

80. An apparatus according to claim 75, wherein the item identifier is an element of a promotional offer.

81. An apparatus according to claim 75, wherein the item information comprises at least one of item specifications, warranty information, executable software, item availability information, Web page data, and a machine-readable version of a text identifier.

82. An apparatus according to claim 81, wherein the item information comprises software for conducting optical character recognition.

83. An apparatus according to claim 75, wherein the item identifier is located proximate to a location, and wherein the item information relates to the location.

84. An apparatus according to claim 75, wherein the item information comprises an expiration date.

85. An apparatus according to claim 84, the storage device storing instructions adapted to be executed by said processor to record the expiration date in a calendar.

86. An apparatus according to claim 85, wherein the item identifier is an element of a promotional offer.

87. An apparatus according to claim 86, wherein the item identifier is printed in circulated materials.

88. An apparatus according to claim 85, wherein the calendar is a countdown calendar.

89. An apparatus to provide item information, comprising:
a processor; and
a storage device in communication with said processor and storing instructions adapted to be executed by said processor to:
receive an image of an item identifier; and
determine, based on the received image, item information associated with an item identified by the item identifier.

90. An apparatus according to claim 89, wherein the image is received from a device.

91. An apparatus according to claim 90, the storage device storing instructions adapted to be executed by the processor to transmit the item information to the device.

92. An apparatus according to claim 90, the storage device storing instructions adapted to be executed by the processor to transmit the item information to a second device.

93. An apparatus according to claim 90, the storage device storing instructions adapted to be executed by the processor to:
receive a second image of a second item identifier from a second device; and
determine, based on the received second image, item information associated with a second item identified by the second item identifier.

94. An apparatus according to claim 89, wherein the instruction adapted to be executed by the processor to determine item information comprises an instruction adapted to be executed by the processor to translate the received image into an identification code.

95. An apparatus according to claim 94, wherein the instruction adapted to be executed by the processor to determine item information comprises an instruction adapted to be executed by the processor to identify the item information as being associated with the identification code.

96. An apparatus according to claim 95, wherein the instruction adapted to be executed by the processor to identify the item information comprises an instruction adapted to be executed by the processor to transmit the identification code to a device.

97. An apparatus according to claim 96, wherein the instruction adapted to be executed by the processor to identify the item information comprises an instruction adapted to be executed by the processor to receive the item information from the device.

98. An apparatus according to claim 96, wherein the device transmits the item information to a device from which the image was received.

99. An apparatus according to claim 89, wherein the item identifier comprises at least one of a barcode, a VCRplus code, text, a portion of the item, a color, and a texture.

100. An apparatus according to claim 99, wherein the item identifier is a Uniform Resource Locator.

101. An apparatus according to claim 89, wherein the item identifier is an element of a promotional offer.

102. An apparatus according to claim 89, wherein the item information comprises at least one of item specifications, warranty information, executable software, item availability information, Web page data, an expiration date, and a machine-readable version of a text identifier.

103. An apparatus according to claim 102, wherein the item information comprises software for conducting optical character recognition.

104. An apparatus according to claim 89, wherein the instruction adapted to be executed by the processor to determine item information comprises an instruction adapted to be executed by the processor to:
determine a type of the received image; and
determine a medium to obtain item information based on the type.

105. An apparatus according to claim 89, wherein the item identifier is located proximate to a location, and wherein the item information relates to the location.

106. An apparatus according to claim 89, the storage device storing instructions adapted to be executed by the processor to receive payment from a seller of the item.

107. An apparatus according to claim 106, wherein the payment is based on a number of times the image is received.

108. An apparatus according to claim 106, wherein the payment is based on an increase in the seller's revenue.

109. A method according to claim 1, wherein the item identifier comprises first text in a first language and the item information comprises second text in a second language, wherein the item information is in a machine-readable format, and wherein the second text represents a translation of the first text from the first language to the second language.

110. A method according to claim 15, wherein the item identifier comprises first text in a first language and the item information comprises second text in a second language, wherein the item information is in a machine-readable format, and wherein the second text represents a translation of the first text from the first language to the second language.

111. A medium according to claim 41, wherein the item identifier comprises first text in a first language and the item information comprises second text in a second language, wherein the item information is in a machine-readable format, and wherein the second text represents a translation of the first text from the first language to the second language.

112. A medium according to claim 55, wherein the item identifier comprises first text in a first language and the item information comprises second text in a second language, wherein the item information is in a machine-readable format, and wherein the second text represents a translation of the first text from the first language to the second language.
